(19) United States
(12) Patent Application Publication
(10) Pub. No.: US 2012/0325373 A1
(43) Pub. Date: Dec. 27, 2012

(54) METHOD FOR TREATMENT OF METAL SURFACE, AND SURFACE-MODIFIED METAL PRODUCT

(75) Inventors: Yasuhiro Morizono, Kumamoto (JP); Sadahiro Tsurekawa, Kumamoto (JP); Tatsuya Sako, Hyougo (JP); Hiroyuki Nemoto, Shiga (JP); Yuka Kawano, Yamaguchi (JP)

(73) Assignee: National University Corporation Kumamoto University, Kumamoto (JP)

(21) Appl. No.: 13/575,720

(22) PCT Filed: Dec. 29, 2010
(86) PCT No.: PCT/JP2010/073825

§ 371 Date: Aug. 20, 2012

(30) Foreign Application Priority Data
Jan. 29, 2010 (JP) 2010-017567

(51) Int. Cl. C23C 8/24; B32B 15/04; C23C 8/26

(52) U.S. Cl. 148/230; 148/238; 148/237; 148/317; 148/318

(57) ABSTRACT

Provided is a method of treating a metal surface, which can improve surface properties of a target metal, such as surface hardness and wear resistance in a simple manner and at low cost using very simple equipment alone, and which can prevent the deterioration of the metal to create high added value. The present invention is comprised of a method of treating a metal surface, characterized in that: heat-treating a target metal (10) to be surface-modified in nitrogen gas atmosphere (S), in such a state where the target metal (10) is buried in a carbon source powder (12) comprising a carbon powder and a powder of iron or an iron alloy mainly comprising iron and containing carbon, whereby the surface of the target metal (10) is at least nitrided or nitrogen-absorbed to modify the surface.

### BACKGROUND OF THE INVENTION

1. Technical Field

The present invention relates to a method of treating a metal surface, which modifies the surface of a metal material including a pure metal, an alloy, a composite material or the like, and a surface-modified metal product.

2. Background Art

Titanium is a material having high specific strength and excellent corrosion resistance so that it is actually utilized for or expected to be applied to various fields, such as industrial parts for spacecrafts/aircrafts, automobiles, motorcycles and the like; structural materials for civil engineering, buildings and the like; consumer goods; and the like. However, there is a problem that titanium has limited applications for members which require high wear resistance such as sliding parts in automobile engines, because titanium disadvantageously has relatively low hardness and inferior wear resistance. Accordingly, a variety of technologies have been proposed for modifying the surface of titanium and other metal materials in order to improve surface hardness and wear resistance thereof Conventionally, for technologies to modify the surface of titanium and metal materials, known are methods of applying a coating on a metal surface, such as thermal spraying, the PVD (Physical Vapor Deposition) method, the CVD (Chemical Vapor Deposition) method; and methods of changing the composition on a metal surface, such as cementation and nitridization (See, for example, Patent Literatures 1, 2, 3, 4, Nonpatent Literatures 1, 2). For example, Patent Literature 1 proposes a technology to form a TiC layer on the surface of a titanium material by high-temperature treatment of an aluminium-containing titanium alloy stacked in layers with a carbon material. Moreover, Patent Literature 2 proposes a technology to form a surface layer comprising carbide of chromium and the like by the molten-salt method and the like after cementation of the surface of a titanium material. Moreover, Patent Literature 3 proposes a technology to form a coating on a metal product by covering the metal product with a pack cementation powder and a fine powder, and then heat-treating it in vacuum space. Moreover, Nonpatent Literature 1 discloses a technology for nitridization of titanium by nitrogen gas. Moreover, Patent Literature 4 and Nonpatent Literature 2 disclose a technology to form a carbonitride layer on a surface of titanium by placing titanium in a vessel made of graphite, and then heat-treating it at the temperature between 1100 and 1300° C. for 10 to 90 minutes under nitrogen atmosphere. On the other hand, materials with excellent wear resistance are not limited to those prepared by surface-treatment of titanium as described above, but composite materials such as cermet made of a fine powder of a hard compound and the like are used. In that context, titanium is processed into a fine powder of titanium nitride or titanium carbide and is used as a raw material for a composite material (See, for example, Patent Literature 5).

### CITATION LIST

### Patent Literature

Patent Literature 1: Japanese Patent Laid-Open No. 2004-83939

Patent Literature 2: Japanese Patent Laid-Open No. H5-140725

Patent Literature 3: Japanese Patent Laid-Open No. 2007-113081

Patent Literature 4: Japanese Patent Laid-Open No. 2002-80958

Patent Literature 5: Japanese Patent Laid-Open No. H1-96005

### Nonpatent Literature

Nonpatent Literature 1: Takamura, Akira, “Nitriding of Titanium,” J. Japan Inst. Metals, 24(9); 565-569 (1960).

Nonpatent Literature 2: Matsuura, K. and Kudoh, M., “Surface modification of titanium by a diffusional carbonitriding method,” Acta Materialia, (US), 12 Jun. 2002, Vol 50, Issue 10, 2693-2700.

### SUMMARY OF INVENTION

### Technical Problem

With regard to a conventional method of treating the surface of a titanium material, thermal spraying method can not realize a smoothed surface on a material so that mechanical polishing after surface treatment is required, and thus the process is complicated and this method is inferior in terms of practicality. Moreover, in addition to the need of expensive special equipment, the PVD method and the CVD method suffer low efficiency and may cause detachment of a surface-modified layer. In the method described in Patent Literature 1, in case that the shape of a titanium material is complex such as having a curved surface or bumps and dips, the process may be complicated or the treatment may be difficult because a carbon material and the like is required to be preprocessed to fit with the shape of the curved surface or the bumps and dips of the titanium material. In the method described in Patent Literature 2, after cementation of a titanium material, further cementation of chromium and the like is required on the titanium material, which may be problematic that this method involves many processes, is complicated, and is costly. In the method of Patent Literature 3, a fine powder further requires to be placed around the powder which covers a base material, and one needs to handle two powders having different particle sizes, making the method demanding. In addition, a small-diameter powder which covers the outside is sintered, and one needs to break the sintered coating when taking out a product after treatment, making the method complicated on the whole. Moreover, in the conventional method such as Nonpatent Literature 1, where the surface of titanium is nitrided, a layer of titanium oxide is readily formed on the surface of the titanium material during a heating process, whereby nitriding is not easily promoted, resulting in a thin surface-modified layer and less improved surface hardness even after a long period of treatment. Thus the method has problems that it is inferior in terms of efficiency and practicality. In the methods of Patent Literature 4 and Nonpatent Literature 2, graphite requires to be heat-treated at a relatively high temperature to treat the surface of titanium since graphite is relatively stable. Therefore, the crystalline grains of titanium may become bigger to cause decreased mechanical properties. In addition, many pores (porous) may be formed in a surface-modified layer of titanium to cause decreased hardness. Thus the methods suffer problems of an inferior value of the product. Moreover, since a heating equipment for high temperature heating is very expensive, the installation of the equipment may be a heavy burden and difficult for small and medium-sized enterprises.

The present invention is made in the light of the above existing problems. An object of the present invention is to provide a method of treating a metal surface, which can improve surface properties of a target metal, such as surface hardness and wear resistance in a simple manner and at low cost using very simple equipment alone, and which can prevent the deterioration of the metal to create high added value.

### Solution to Problem

In order to solve the above problems, the present invention is comprised of a method of treating a metal surface, characterized in that: heat-treating a target metal (10) to be surface-modified in nitrogen gas atmosphere (S), in such a state where the target metal (10) is buried in a carbon source powder (12) comprising a carbon powder and a powder of iron or an iron alloy mainly comprising iron and containing carbon, whereby the surface of the target metal (10) is at least nitrided or nitrogen-absorbed to modify the surface. The iron alloy may contain alloy elements other than iron and carbon, for example, nickel, chromium, molybdenum and the like.

Moreover, a heating temperature may be set between 600° C. and 1200° C.

Preferably, the heating temperature may be set between 700° C. and 1000° C.

Moreover, the carbon powder may be a powder of a material mainly comprising carbon, such as graphite or activated carbon or charcoal.

Moreover, the iron alloy may comprise carbon steel or cast iron.

Moreover, the carbon source powder (12) may be prepared by mixing a carbon powder and a powder of carbon steel or cast iron in a ratio ranging between 3:7 and 7:3 by volume.

Moreover, the target metal may be titanium or a titanium alloy.

Moreover, the target metal may be stainless steel.

Moreover, the target metal may be a metal of the 4A, 5A, 6A groups in the periodic table, or an alloy thereof. Namely, the target metal may be any metal of titanium, zirconium, hafnium for the 4A group in the periodic table; vanadium, niobium, tantalum for the 5A group; chromium, molybdenum, tungsten for the 6A group; or may be an alloy formed by adding another element to any of these metals.

Moreover, the target metal may be a composite material of a metal of the 4A, 5A, 6A groups in the periodic table or an alloy thereof and stainless steel.

Moreover, the present invention is comprised of a surface-modified metal product obtained by the method of treating a metal surface described above, characterized in that a surface-modified layer is formed which is at least nitrided or nitrogen-absorbed.

### Advantageous Effect of Invention

According to the method of treating a metal surface of the present invention, by heat-treating a target metal to be surface-modified in nitrogen gas atmosphere, in such a state where the target metal is buried in a carbon source powder comprising a carbon powder and a powder of iron or an iron alloy mainly comprising iron and containing carbon, the surface of the target metal is at least nitrided or nitrogen-absorbed to modify the surface. Thus, a hard modified layer with high surface hardness and wear resistance can be formed on the surface of the metal to improve surface properties by simple operations and at low cost using very simple equipment alone. Moreover, a surface treatment can be easily performed regardless of the shape of a target metal and, because a carbon source powder is not easily sintered, the metal can be easily taken out after the treatment. Therefore, the treatment efficiency is also good. As a result, even small and medium-sized enterprises can employ the present method at low cost and can attempt extending practicality of the metal to various fields. In particular, since that the carbon source powder is prepared by mixing a carbon powder and a powder of iron or an iron alloy, the reactivity of nitriding and carbonitriding as well as the treatment efficiency can be improved compared with a surface treatment with a carbon powder alone. Thus a better surface modification can be performed to produce higher hardness. In addition, a surface modification treatment can be achieved at a relatively low heating temperature so that the deterioration of mechanical properties of a metal can be prevented and the formation of porous on a surface-modified layer is also well prevented. As a result, a product having good practicality and high quality can be provided.

Moreover, by setting the heating temperature between 600° C. and 1200° C., a target metal can be efficiently surface-modified, and the deterioration of mechanical properties of the metal can also be prevented.

Moreover, by setting the heating temperature between 700° C. and 1000° C., a target metal can be efficiently surface-modified so that the metal can be practically used for industrial parts such as automotive components and the like as well as biomaterials. At the same time, for example, in the case of a metal such as titanium and stainless steel, the deterioration of mechanical properties and the formation of porous on a surface-modified layer can be more reliably prevented to ensure that desired properties of the metal is maintained or controlled. Moreover, the cost for heating equipments can be reduced and even small and medium-sized enterprises can introduce the equipments rather easily.

Moreover, since the carbon powder is to be a powder of a material mainly comprising carbon such as graphite or activated carbon or charcoal, a better surface treatment can be achieved, and the carbon powder is available at relatively low cost so that surface treatment can be performed at low cost.

Moreover, since the iron alloy comprises carbon steel or cast iron, an iron alloy powder with high performance on surface treatment can be prepared, and the iron alloy powder is available at relatively low cost so that surface treatment can be performed at low cost.

Moreover, since the carbon source powder is prepared by mixing a carbon powder and a powder of carbon steel or cast iron in a ratio ranging from 3:7 to 7:3 by volume, the surface of a target metal can be treated to achieve higher hardness so that a good surface-modified layer can be formed to obtain a metal product with a higher value.

Moreover, in the case that the target metal is titanium or a titanium alloy, titanium, which has high specific strength and excellent corrosion resistance and mechanical properties, can be effectively surface-modified to provide a titanium product with improved practicality.

Moreover, in the case that the target metal is stainless steel, stainless steel, which is relatively inexpensive and has excellent corrosion resistance, can be effectively surface-modified to provide a stainless steel product with improved practicality. Further, for example, surface-austenitized stainless steel can be obtained by effective nitrogen absorption without adding expensive nickel to stainless steel. Therefore, stainless steel with high surface hardness can be manufactured at low cost. In addition, the allergy due to nickel can be prevented so that stainless steel can be used as a biomaterial.

Moreover, in the case that the target metal is a metal of the 4A, 5A, 6A groups in the periodic table or an alloy thereof, the metal, which has excellent mechanical properties similar to titanium, can be effectively surface-modified to provide a metal product with improved practicality.

Moreover, in the case that the target metal is a composite material comprising a metal of the 4A, 5A, 6A groups in the periodic table or an alloy thereof, and stainless steel, the composite material, which has both of the properties of a metal such as titanium or an alloy thereof and those of stainless steel, can be effectively surface-modified to provide a composite material with improved practicality.

Moreover, a surface-modified metal product according to the present invention, which is obtained by the method of treating a metal surface described above, and on which a surface-modified layer that is at least nitrided or nitrogen-absorbed is formed, simultaneously has the properties of the target metal itself and a surface-modified layer having high hardness and wear resistance. Thus a high-value metal product having broad applicability in various fields can be provided at low cost.

### BRIEF DESCRIPTION OF THE DRAWINGS

FIG. 1 shows a schematic illustration for the method of treating a metal surface according to an embodiment of the present invention.

FIG. 2 shows an electron microscopy image of a cross section at the surface side of a titanium product obtained in Example 1.

FIG. 3 shows a table in which surface hardness and observed results of surface color are compared for the titanium products from Examples 1 to 5 and Comparative Examples 1 and 2.

FIG. 4 shows X-ray diffraction patterns for the surface of the titanium products from Examples 1 to 5 and Comparative Example 1.

FIG. 5 shows an X-ray diffraction pattern for the surface of the titanium product from Comparative Example 2.

FIG. 6 shows a graph indicating measured results of surface hardness for the titanium products obtained in Examples 6 to 11.

FIG. 7 shows a graph indicating a relationship between the depth from the surface and hardness of the titanium alloy from Example 12.

FIG. 8 shows light microscopy images for the cross sections of the round rods of the stainless steel obtained from Comparative Example 3 and Example 13.

FIG. 9 shows a table in which surface hardness is compared for the stainless steel from Examples 13 and 14, and Comparative Example 3.

FIG. 10 shows X-ray diffraction patterns for the surface of the stainless steel from Comparative Example 3 and Example 13.

### DESCRIPTION OF EMBODIMENTS

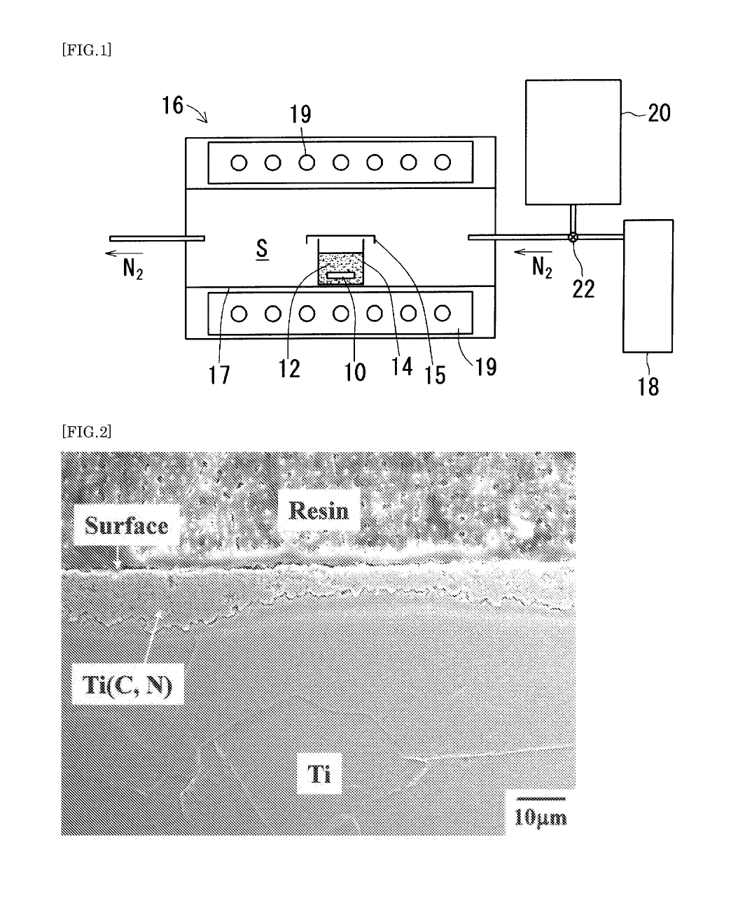

Now, referring to the accompanying drawings, embodiments of the method of treating a metal surface and surface-modified metal products according to the present invention will be described. The method of treating a metal surface according to the present invention is a kind of surface modification method by a dry process to improve surface hardness, wear resistance and the like of a metal material used as various industrial parts, biomaterials, structural materials, consumer goods and the like. FIG. 1 shows an embodiment of the method of treating a metal surface according to the present invention. In this embodiment, as shown in FIG. 1, the method of treating a metal surface is a surface-hardening method in which by heat-treating a target metal (10) in nitrogen gas (N₂) atmosphere, in such a state where the target metal is buried in a carbon source powder (12), the surface of the metal itself is nitrided or carbonitrided, or nitrogen-absorbed or carbon-absorbed to form a hardened surface-modified layer.

Specifically, in this embodiment, the target metal (10) comprises, for example, pure titanium; an titanium alloy formed by adding an alloy element such as aluminium, molybdenum, copper, manganese; stainless steel formed by adding chromium, nickel, etc. to iron; a metal of the 4A, 5A, 6A groups in the periodic table or an alloy thereof formed by adding another element; a composite material formed of a metal of the 4A, 5A, 6A groups in the periodic table or an alloy thereof and stainless steel. In the case that the target metal (10) is a titanium product comprising titanium or a titanium alloy, a surface-modified layer of titanium nitride or titanium carbonitride is formed by allowing nitrogen and carbon to diffuse on the surface layer of the titanium product. Alternatively, in the case that the target metal (10) is stainless steel, a surface-modified layer in which iron and chromium in stainless steel is nitrided or carbonitrided, or nitrogen-absorbed or carbon-absorbed is formed by allowing nitrogen and carbon to diffuse and be absorbed in its surface layer. Alternatively, in the case that the target metal (10) is a metal of the 4A, 5A, 6A groups in the periodic table or an alloy thereof, which readily forms nitrides or carbides similar to titanium, a surface-modified layer of nitrides or carbonitrides is formed by allowing nitrogen and carbon to diffuse on its surface layer as described for titanium. Alternatively, in the case that the target metal (10) is a composite material, for example, a surface-modified layer is formed in which nitrogen and carbon are diffused on the surface of either a metal of the 4A, 5A, 6A groups in the periodic table or stainless steel, or the both. The target metal is not limited to the above examples, but other metal materials that can be surface-modified by nitriding can be used, such as a pure metal, an alloy, a composite material in which a pure metal and an alloy, or a pure metal or an alloy and a non-metal are combined together in an integrated fashion. In FIG. 1, the target metal (10) is, for example, shaped in a plate-like form. The target metal (10) is applicable to, for example, parts of automobiles/motorcycles, spacecrafts/aircrafts, ships; tools for material processing such as a tool bit; biomaterials such as artificial joints; structural materials for civil engineering/buildings such as board, column; chemical reactors; consumer goods; those shaped and sized according to other various intended uses.

Upon heating, a carbon source powder (12) can serve as a reducing means or an anti-oxidization means which can provide reducing effects on the surface of a target metal or anti-oxidization effects on the metal surface. The carbon source powder is a carbon source to supply carbon which easily reacts with oxygen upon heating. Generally, when a target metal is heated, its surface is easily oxidized due to a reaction with surrounding oxygen. However, by heating a target metal in the presence of the carbon source powder (carbon) on the surface, the carbon reduces the metal surface, or suppresses the oxidization of the metal surface while generating carbon monoxide or carbon dioxide by reacting with oxygen around the metal. As a result, the carbon source powder serves as a nitriding promoting means in nitrogen gas atmosphere, which promotes a reaction between the surface of a metal and nitrogen. Further, the carbon source powder can also serve as an element which allows carbon to penetrate into and diffuse on the surface of a target metal for surface-modification. In this embodiment, because the carbon source is in a form of powder, it well contacts with or comes close to the surface of a target metal according to various shapes and sizes of the target metal to effectively achieve reduction, anti-oxidation of the metal surface. At the same time, since space is formed between powder particles, the carbon source powder can maintain a reaction between a metal surface and nitrogen.

An example of the carbon source powder comprises a mixed powder containing, for example, at least two kinds of powder; a carbon powder and a powder of iron or an iron alloy mainly comprising iron and containing carbon. For example, the carbon powder comprises a carbon material mainly comprising carbon such as an activated carbon powder, a graphite powder, a charcoal powder. Carbon-containing iron alloys include, for example, carbon steel containing carbon in iron; cast iron containing more carbon than carbon steel; other iron-based alloys containing carbon; stainless steel containing chromium, nickel, etc. other than iron/carbon; special steel (alloy steel) containing any other alloy elements. For example, a carbon-containing iron alloy is preferred to contain about 0.1 to 6.7% of carbon by weight, preferably about 0.1 to 4% of carbon by weight. In addition to a carbon powder and a powder of iron or an iron alloy, a carbon source powder may be mixed with, for example, a powder of a carbon compound such as silicon carbide, a powder of other materials which can supply carbon upon heating to enable reduction or anti-oxidation of the surface of a target metal. Preferably, the carbon source powder should not be easily sintered each other upon heating and should not interfere with the reaction between nitrogen and the metal buried in the powder. The carbon source powder preferably maintains space between powder particles to allow the passage of gas and the like (nitrogen, carbon monoxide and carbon dioxide) even at an advanced stage of the treatment. The carbon source powder may be mixed with, for example, an anti-sintering agent for the powder, such as aluminum oxide.

Preferably, the carbon source powder comprises a mixed powder of a carbon powder and a powder of a carbon-containing iron alloy such as carbon steel or cast iron. As shown in Examples below, experiments indicate that a treatment effect of the surface of a target metal is higher when using, as a carbon source powder, a mixture of a carbon powder and an iron and steel powder in a predetermined ratio, compared with using a carbon powder alone. Although the reason for this is not known in detail, a high reactivity of carbon released from carbon steel or cast iron upon heating appears to allow carbon and oxygen to react easier as the whole powder, compared with when using a carbon powder alone which is relatively stable even at high temperature. Moreover, iron in carbon steel may also contribute to reduction and anti-oxidation of the surface of a metal. As a result, reduction and anti-oxidation of the surface of a metal, and nitriding reactions appear to be more promoted. Furthermore, since sintering occurs easily upon heating when using an iron and steel powder alone, sintering may be well prevented by mixing a carbon powder which is not easily sintered. That is, a mixed powder of a carbon powder and a powder of carbon steel or the like appears to simultaneously provide a highly pure carbon source, a highly reactive carbon source and a sintering inhibition function to achieve an effective surface treatment of a metal. Furthermore, the high reactivity can allow an effective surface treatment of a metal even at lower temperature, compared with using a carbon powder alone. As a result, the deterioration of mechanical properties of a target metal by heating can be prevented, and at the same time, a porous surface layer can also be well prevented. A mixing ratio of a carbon powder and a powder of carbon steel or cast iron may be any ratios, but for example, a ratio ranging between 3:7 and 7:3 by volume is preferred. In particular, when a carbon powder and a powder of carbon steel or cast iron are mixed in the same volume ratio, a surface modification effect of a target metal is high.

The mean particle diameter of a carbon source powder is set to be, for example, in the order of micrometers, such as several micrometers to several hundred micrometers. Since an extremely small particle diameter of a carbon source powder easily causes sintering of the powder upon heating, the formation of a hardened surface layer will be inhibited due to the suppressed reaction between nitrogen and a target metal in the powder, and the metal will be difficult to remove after treatment. Moreover, when the particle diameter of a carbon source powder is too large, functions such as reduction and anti-oxidation of a metal surface, and promotion of nitriding is decreased, resulting in inferior treatment efficiency. When two or more carbon source powders are mixed, as in a mixed powder of a carbon powder and a powder of carbon steel or the like, the particle sizes are preferred to be equalized.

As shown in FIG. 1, the carbon source powder (12) is provided in an amount such that the whole target metal (10) is completely covered and buried. For example, the carbon source powder (12) is filled into the heat-resistant vessel (14) having a volume large enough to completely accommodate the target metal (10). In FIG. 1, the vessel (14) is, for example, closed with the lid (15), but nitrogen gas can be introduced into the vessel (14) even when the vessel is closed with the lid. The lid (15) serves to prevent the carbon source powder (12) from scattering or being sucked into a vacuum pump when reducing pressure in the closed space (S) in which the vessel (14) is placed, using the vacuum pump as described below. The lid (15) is, for example, comprised of heat-resistant ceramic, but it may be made of paper which is burned down at the time of heating to open the vessel. The lid (15) is not necessarily required. For example, the carbon source powder (12) is arranged to make direct contacts with the entire surface of the target metal (10), and further arranged to cover the surface of the metal with a certain thickness from the surface. For example, the metal (10) may be arranged to make contacts with the bottom of the vessel (14), and then buried by filling with the carbon source powder over it. Moreover, an aspect is not limited to that the entire metal is completely buried by the carbon source powder (12), but, for example, only a potion of the metal may be buried in the case that the portion of the metal (10) is desired to be surface-treated. Moreover, an aspect is not limited to that the carbon source powder is filled into a vessel, but the target metal (10) may be placed on a plate and the like, and then covered with a heap of the carbon source powder over it for the treatment.

Nitrogen gas atmosphere is formed by filling the closed space (S) with nitrogen gas N₂, as shown in FIG. 1. Nitrogen gas atmosphere serves as both a nitrogen supplying means to provide a nitrogen source for nitriding the surface of a target metal, and an anti-oxidation means of the metal. In FIG. 1, the closed space (S) comprises, for example, an in-furnace space in the heating furnace (16), i.e., the heat-treatment chamber (17). The treatment chamber (17) is, for example, equipped with a re-closable door not shown in the figure to load and unload a target metal. In this embodiment, nitrogen gas atmosphere is maintained by allowing nitrogen gas (N₂) flow into the closed space (S) at the one end from the gas cylinder (18) through a supply line at a given flow rate, while discharging it out of the closed space (S) at the other end through an exhaust line. Nitrogen gas atmosphere may be maintained in the closed space (S) without a flow of nitrogen gas. When forming nitrogen gas atmosphere in the closed space (S), for example, first, the air (oxygen) in the closed space (S) is removed by the vacuum pump (20), and then nitrogen gas N₂ is introduced into the closed space (S) from the gas cylinder (18) to form nitrogen gas atmosphere of highly pure nitrogen. Complete removal of oxygen is difficult even by forming nitrogen gas atmosphere, but a good surface treatment may be achieved by preventing oxidation of the target metal using a carbon source powder as described above. In FIG. 1, the vacuum pump (20) is, for example, connected to a nitrogen gas supply line through the switching valve (22). The valve (22) can be appropriately switched between for generation of vacuum in the closed space (S) by the vacuum pump (20) and for supply of nitrogen into the closed space S from the gas cylinder (18). For a heating means, the heating furnace (16) having the closed space (S) therein is used. For example, the heating furnace (16) is an electric furnace in which the heating member (19) can be arranged around the heat-treatment chamber (17) to maintain the heat-treatment chamber (17) at high temperature for a long time of period. The heating temperature is set to be, for example, between 500° C. and a temperature below the melting point of a target metal, preferably between 600° C. and 1200° C., more preferably between 700° C. and 1000° C. If the heating temperature is too low, reduction, anti-oxidation, and nitriding reactions of the surface a target metal by a carbon source powder will hardly occur. On the other hand, the higher the heating temperature is, the harder the metal surface can be modified in a short time. However, if the heating temperature is too high, the structure and mechanical properties of a target metal itself will be damaged, and the surface will become porous. Therefore the metal may be deteriorated, resulting in a lowered product value. Therefore, the heating temperature is desirably set to the lowest possible temperature in the range of a heating temperature at which surface modification is possible. In this embodiment, a carbon source powder comprising a mixed powder of a carbon powder and an iron alloy powder as described above can allow the formation of a surface modified layer having relatively high hardness at relatively low temperature, for example, at or below 1000° C. In the case that a target metal is titanium or stainless steel, this can more reliably prevent a change in the structure of the metal or the deterioration of mechanical properties of the metal. A heating duration may be any time of period. The longer the heating duration is, the more thickly a modified layer is formed on the surface of a target metal. For example, as in Example 1 below, a 10-μm modified layer on a titanium product is obtained by setting the heating temperature and the heating duration to 1000° C. and 1 hour respectively (See FIG. 2).

As described above, in the method of treating a metal surface according to the present invention, by heat-treating a target metal in nitrogen atmosphere in such a state where the target metal is buried in a carbon source powder, the reaction between nitrogen and the metal surface is promoted while allowing reduction and anti-oxidation of the metal surface through oxidation of the carbon from the carbon source powder. At the same time, the carbon from the carbon source powder also reacts with the metal surface, and penetrates into a layer on the metal surface. Thereby, a surface-modified layer in which nitrogen and carbon are diffused and absorbed is formed on the metal surface. For example, in the case that the target metal is titanium, nitrogen penetrates into the surface of titanium to form a titanium nitride layer (a TiN layer), or both nitrogen and carbon penetrate into the surface of titanium to form a titanium carbonitride layer (a Ti(C, N) layer). This will modify the surface of the titanium product itself to improve surface hardness, wear resistance. Moreover, in the case that the target metal is a stainless steel product, nitrogen penetrates into the surface of stainless steel such that iron or chromium is nitrided or nitrogen-absorbed to allow the surface of the stainless steel product itself to be modified. In particular, for example, in the case of stainless steel comprising iron and chromium (ferritic stainless steel such as SUS430), the surface of stainless steel can be austenitized to improve hardness, wear resistance and corrosion resistance without adding expensive nickel. Thus, a metal surface can be treated in a simple manner using a very simple facility or equipment alone such as a heating furnace but not a special equipment. Furthermore, high-value metal products can be provided at low cost, and practically used in a wide range of fields.

### EXAMPLES

In the followings, specific embodiments of the method of treating a metal surface according to the present invention will be described.

### Example 1

A small plate-like piece of pure titanium with a length and width of 5 mm×5 mm and a thickness of 0.5 mm was used as a target metal (10). As a carbon source powder (12), used was a mixed powder in which an activated carbon powder with a mean particle diameter of 20 μm and a carbon steel powder (containing about 0.8% of carbon by weight) with a mean particle diameter of 5 μm are mixed in a ratio of 3:7 by volume. As shown in FIG. 1, the vessel (14) is filled with the carbon source powder (12), and the plate-like titanium product (10) is completely buried in the carbon source powder (12), and placed in the treatment chamber (17) in the heating furnace (16). Then oxygen in the treatment chamber (17) is decompressed by reducing pressure in the treatment chamber (17) using the vacuum pump (20) in such a state where the vessel (14) is closed with the lid (15) to prevent scattering of the carbon source powder in the space. Then, nitrogen gas (purity, 4N (99.99% or more)) is allowed to flow into the treatment chamber (17) to create nitrogen gas atmosphere in the closed space (S). The heating furnace (16) was heated at 1000° C. in such a state where nitrogen gas atmosphere is maintained by allowing nitrogen gas N₂ to flow into the treatment chamber at the one end while allowing nitrogen gas N₂ to flow out of the chamber at the other end. After one hour of treatment, the heating furnace was naturally-cooled, and then the titanium product was taken out.

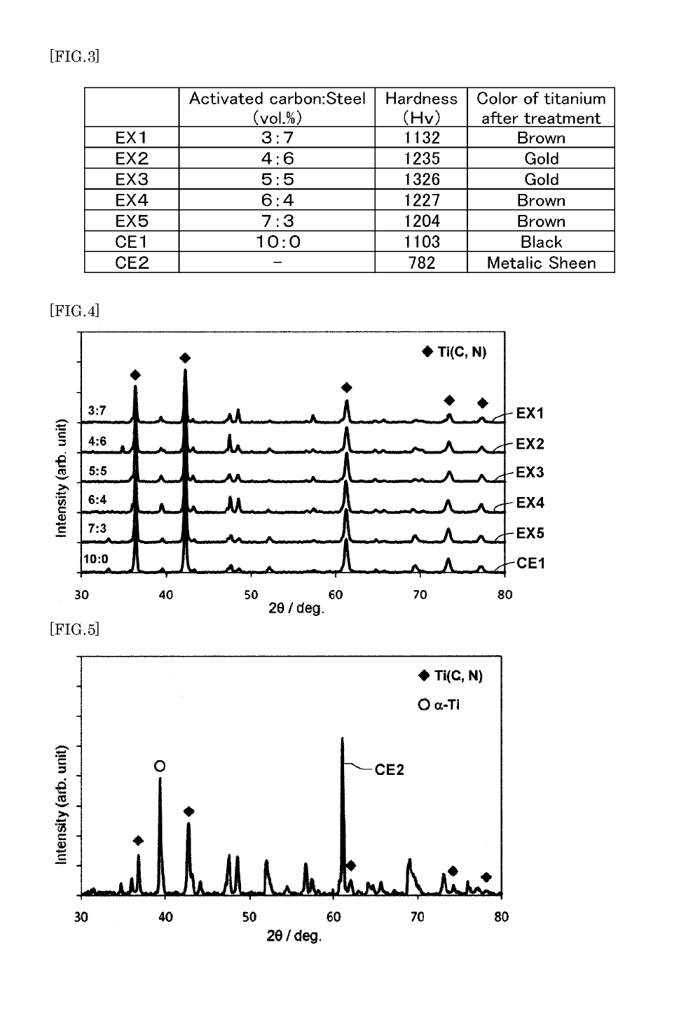

As shown in FIG. 2, when a cross-section of the surface of the titanium product after treatment in Example 1 was observed by scanning electron microscopy, the formation of a titanium carbonitride (Ti (C, N)) layer with a thickness of 10 μm was observed in the surface (surface) side of titanium (Ti). In the electron microscopy image of FIG. 2, resin (Resin) is attached to the surface (surface) to support the titanium product. FIG. 3 shows the results from the measurements of surface hardness Hv and the observation of surface color of the titanium products after treatment. The surface hardness Hv is a result as tested for Vickers hardness. The surface color of the titanium products after treatment was visually determined FIG. 4 shows the results of the X-ray diffraction of the surface of the titanium product after treatment (See FIG. 3, FIG. 4, EX1).

### Example 2

Except that the carbon source powder was prepared by mixing an activated carbon powder and a carbon steel powder in a ratio 4:6 by volume, the same conditions as Example 1 were used for the treatment. Then the measurement of surface hardness, the observation of surface color and X-ray diffraction were performed for the titanium product after treatment (See FIG. 3, FIG. 4, EX2).

### Example 3

Except that the carbon source powder was prepared by mixing an activated carbon powder and a carbon steel powder in a ratio of 5:5 by volume, the same conditions as Example 1, 2 were used for the treatment. Then the measurement of surface hardness, the observation of surface color and X-ray diffraction were performed for the titanium product after treatment (See FIG. 3, FIG. 4, EX3).

### Example 4

Except that the carbon source powder was prepared by mixing an activated carbon powder and a carbon steel powder in a ratio of 6:4 by volume, the same conditions as Examples 1 to 3 were used for the treatment. Then the measurement of surface hardness, the observation of surface color and X-ray diffraction were performed for the titanium product after treatment (See FIG. 3, FIG. 4, EX4).

### Example 5

Except that the carbon source powder was prepared by mixing an activated carbon powder and a carbon steel powder in a ratio of 7:3 by volume, the same conditions as Examples 1 to 4 were used for the treatment. Then the measurement of surface hardness, the observation of surface color and X-ray diffraction were performed for the titanium product after treatment (See FIG. 3, FIG. 4, EX5).

### Comparative Example 1

Except that the carbon source powder comprised only an activated carbon powder (the ratio of activated carbon powder:carbon steel powder was 10:0), the same conditions as Examples 1 to 5 were used for the treatment. Then the measurement of surface hardness, the observation of surface color and X-ray diffraction were performed for the titanium product after treatment (See FIG. 3, FIG. 4, CE1).

### Comparative Example 2

Except that the titanium product were directly placed in the treatment chamber without using any carbon source powder, the same conditions as Examples 1 to 5 were used for the treatment. Then the measurement of surface hardness, the observation of surface color and X-ray diffraction were performed for the titanium product after treatment (See FIG. 3, FIG. 5, CE2).

As shown in the comparison table of FIG. 3, the titanium products treated in Examples 1 to 5 show the surface hardness Hv improved by about 1.4 times or more, as compared with that of the Comparative Example 2, indicating that a highly hardened surface layer can be obtained in the presence of the carbon source powder. For all of Examples 1 to 5 (the carbon source powder comprises a mixed powder of an activated carbon powder and a carbon steel powder), the values of surface hardness Hv are greater than those of Comparative Example 1 (the carbon source powder comprises only an activated carbon powder), indicating that the presence of the carbon steel powder contributes to the improvement in surface hardness. Particularly, in Examples 2 to 5, the values for surface hardness Hv of the titanium products are larger, and the value for Example 3 (activated carbon powder:carbon steel powder, 5:5) is the largest. On the other hand, when the surface color of the titanium products after treatment is compared, for Examples 1, 4 and 5, it changes to brown, for Comparative Example 1, it changes to black, while for Examples 2 and 3, it changes to a golden color. Therefore, in Examples 2 and 3, the formation of a good surface-modified layer can be visually observed.

As shown in FIG. 4, in the X-ray diffraction of the titanium products after treatment, peaks with an strong diffraction intensity were observed at the diffraction angles (the angle 2θ between the incoming direction and the reflecting direction) corresponding to titanium carbonitride Ti (C, N) for all titanium products treated in Examples 1 to 5, indicating that a hard titanium carbonitride Ti(C, N) layer was formed. On the other hand, for the titanium product in Comparative Example 2, as shown in FIG. 5, peaks with strong diffraction intensity were observed at the diffraction angles (the angle 2θ between the incoming direction and the reflecting direction) other than the diffraction angles corresponding to titanium carbonitride Ti(C, N), indicating that there exists something other than Ti(Cc, N). In the case that the target metal is a metal of the 4A, 5A, 6A groups in the periodic table or an alloy thereof, which easily forms nitride and carbide similar to titanium, the same or similar results as the present Examples are also expected to be obtained.

### Example 6

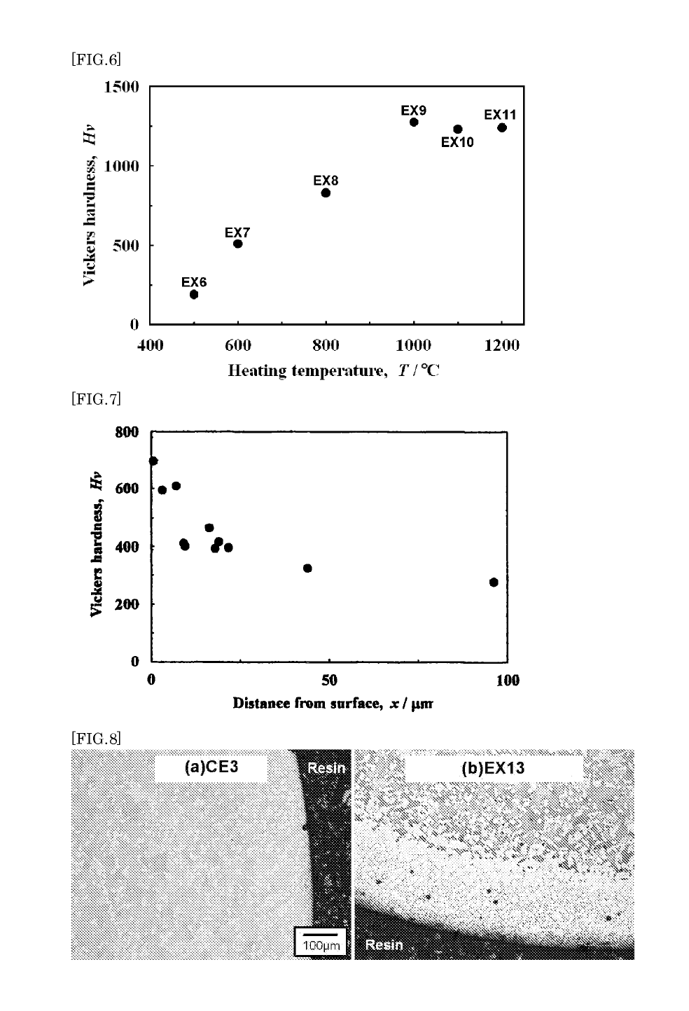

As a target metal, pure titanium was used as above, and the carbon source powder was prepared by mixing an activated carbon powder and a carbon steel powder in a ratio of 6:4 by volume. The heating temperature in the heating furnace was set to 500° C. Other than that, the same conditions (nitrogen atmosphere, the heating duration of 1 hour) as Example 1 were used for the treatment. The surface hardness (Vickers hardness, Hv) of the titanium product after treatment was measured (See FIG. 6, EX6).

### Example 7

Except that the heating temperature in the heating furnace was set to 600° C., the same conditions as Example 6 were used for the treatment, and the surface hardness of the titanium product after treatment was measured (See FIG. 6, EX7).

### Example 8

Except that the heating temperature in the heating furnace was set to 800° C., the same conditions as Examples 6 and 7 were used for the treatment, and the surface hardness of the titanium product after treatment was measured (See FIG. 6, EX8).

### Example 9

Except that the heating temperature in the heating furnace was set to 1000° C., the same conditions as Examples 6 to 8 were used for the treatment, and the surface hardness of the titanium product after treatment was measured (See FIG. 6, EX9).

### Example 10

Except that the heating temperature in the heating furnace was set to 1100° C., the same conditions as Examples 6 to 9 were used for the treatment, and the surface hardness of the titanium product after treatment was measured (See FIG. 6, EX10).

### Example 11

Except that the heating temperature in the heating furnace was set to 1200° C., the same conditions as Examples 6 to 10 were used for the treatment, and the surface hardness of the titanium product after treatment was measured (See FIG. 6, EX11).

FIG. 6 shows a graph indicating the relationship between the heating temperature and the surface hardness of the titanium products after treatment. As shown in FIG. 6, the titanium product obtained in Example 5 (the heating temperature is 500° C.) has a low value of surface hardness (Hv) and shows relatively a low effect of surface modification of titanium. In the case of Examples 6 to 11, i.e., in the case that the heating temperature is higher than or equal to 600° C., it is observed that relatively good surface modification can be achieved. For Example 8 (the heating temperature is 800° C.), the surface hardness was about 800 Hv. From the trend of the graph in FIG. 6, in the case of the heating temperature of 700° C., one can expect that the surface hardness of about 700 Hv or more can be obtained. In the case of the heating temperature of 900° C., one can expect that the surface hardness of 1000 Hv or more can be obtained. Further, for Examples 9 to 11 (the heating temperature is between 1000° C. and 1200° C.), it is observed that the surface hardness of about 1250-1300 Hv can be obtained.

### Example 12

A titanium alloy in which 6% aluminium and 4% vanadium were mixed into titanium (Ti-6Al-4V) was used as a target metal. The carbon source powder was prepared by mixing an activated carbon powder and a carbon steel powder in a ratio of 6:4 by volume. The heating temperature in the heating furnace was set to 800° C. Other than that, the same conditions (nitrogen atmosphere, the heating duration of 1 hour) as in Example 1 were used for the treatment. For the titanium alloy after treatment, Vickers hardness Hv in accordance with the depth from the surface was measured. As shown in FIG. 7, the Vickers hardness is about 700 Hv at the nearest side (0 μm) from the surface of the titanium alloy after treatment, which is gradually decreasing as the depth from the surface is increased. Similar to pure titanium, it is observed that a titanium alloy can also be surface-modified.

### Example 13

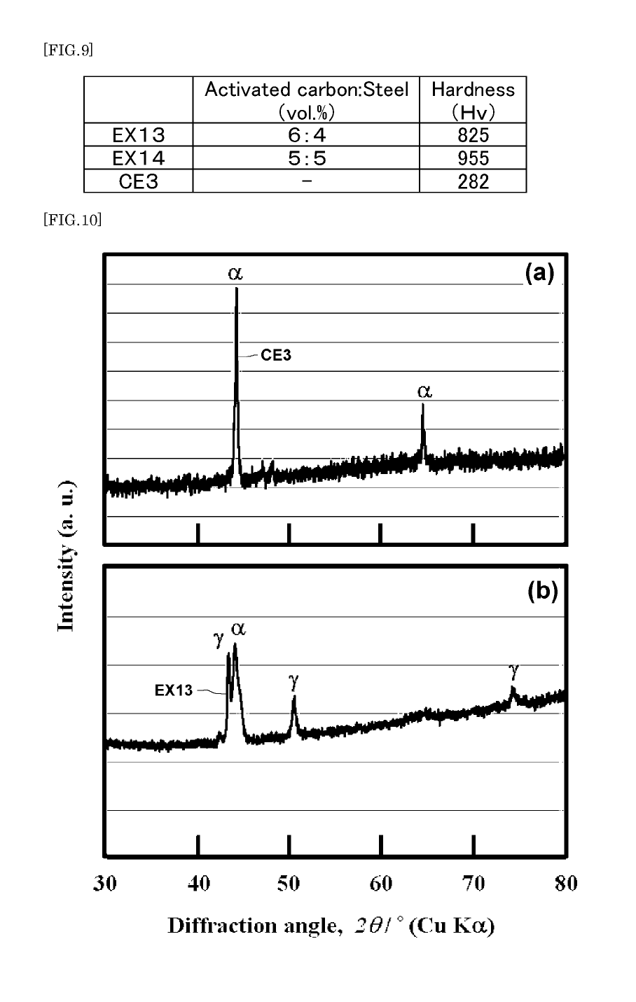

Ferritic stainless steel containing 18% chromium in iron (SUS430) was used as a target metal. The carbon source powder was prepared by mixing an activated carbon powder and a carbon steel powder in a ratio of 6:4 by volume. Except for that, the same conditions (nitrogen atmosphere, the heating temperature of 1000° C., the heating duration of 1 hour) as Example 1 were used for the treatment. In Example 13, the treated stainless steel was quenched with water after the heat-treatment. As shown in FIG. 8(b), FIG. 9, FIG. 10(b), a cross-section of the surface of the stainless steel after treatment was observed by light microscopy, and the surface hardness (Vickers hardness, Hv) was measured, and X-ray diffraction was performed (See FIG. 8(b), FIG. 9, FIG. 10(b), EX13).

### Example 14

The carbon source powder was prepared by mixing an activated carbon powder and a carbon steel powder in a ratio of 5:5 by volume. Except for that, the same conditions as Example 13 were used for the treatment. The surface hardness Hv of the titanium product after treatment was measured (See FIG. 9, EX14).

### Comparative Example 3

Except that stainless steel was directly placed in the treatment chamber without using any carbon source powder, the same conditions as Examples 13, 14 were used for the treatment. A cross-section of the surface of the stainless steel after treatment was observed by light microscopy, and the measurement of surface hardness (Hv) and X-ray diffraction were performed (See FIG. 8(a), FIG. 9, FIG. 10(a), CE3).

As shown in FIG. 8, the observation of the stainless steel product after treatment by light microscopy indicates that a modified layer with a thickness of about 200 μm is formed at the side of the surface. On the other hand, for the stainless steel obtained in Comparative Example 3, no formation of a surface modified layer can be observed at the side of the surface.

As shown in the comparison table of FIG. 9, for the stainless steel treated in Examples 13, 14, the surface hardness Hv is improved by about 3 times or more, as compared with that of Comparative Example 3. Therefore, this indicates that a highly hardened surface layer with high hardness can also be formed on stainless steel. Moreover, the stainless steel obtained in Example 14 shows a larger value of surface hardness Hv than that of Comparative Example 3. This can indicate that for stainless steel as well as titanium, the surface-modified effect is higher for the case that an activated carbon powder is mixed with the equal amount of carbon steel powder, compared with the case that an activated carbon powder is mixed with a larger amount of carbon steel powder. One can expect that in the case that a target metal is austenitic stainless steel such as SUS304 and martensitic stainless steel such as SUS420, surface modification can also be achieved by diffusing nitrogen and carbon as described in Examples 13 and 14 using the surface treatment method according to the present invention.

As shown in FIG. 10(b), for the stainless steel obtained in Example 13, the X-ray diffraction of the stainless steel after treatment showed the peak (γ) with strong diffraction intensity at the diffraction angle (the angle 2θ between the incoming direction and the reflecting direction) corresponding to austenitic stainless steel. This can indicate that a surface-modified layer which is hard and austenitized can be formed without adding nickel to the stainless steel (SUS430). On the other hand, as shown in FIG. 10(a), for the stainless steel treated in Comparative Example 3, the peaks (a) with strong diffraction intensity were observed only at the diffraction angles corresponding to ferrite, and no peak corresponding to austenite was observed.

### Example 15

A composite material formed by joining a pure titanium foil with a thickness of 0.1 mm with a stainless steel (SUS430) with a thickness of 5 mm was used as a target metal. Titanium and stainless steel was joined together by the explosion-cladding method using explosion of explosives. The carbon source powder was prepared by mixing an activated carbon powder and a carbon steel powder in a ratio of 6:4 by volume. Except for that, the same conditions (nitrogen atmosphere, the heating temperature of 1000° C., the heating duration of 1 hour) as Example 1 were used for the treatment. The observation of the surface at the side of titanium of the composite material after treatment indicated that titanium nitride TiN was formed.

In Examples 1 to 15 above, carbon steel was used as an iron alloy powder in the carbon source powder. However, in the case that an activated carbon powder is mixed with cast iron containing more carbon than carbon steel, one can expect that the same or similar results as Examples 1 to 15 can also be obtained. Further, in the case that a graphite powder is used instead of an activated carbon powder, one can expect that the same or similar results as Examples 1 to 15 can also be obtained.

The method of treating a metal surface and a surface-modified metal product according to the present invention described above are not limited to these embodiments and Examples illustrated above, but any modifications can be made without departing from the spirit of the present invention described in the claims.

### INDUSTRIAL APPLICABILITY

The method of treating a metal surface and a surface-modified metal product according to the present invention can provide metal products applicable to, for example, parts in each industry such as automobiles, motorcycles, spacecrafts/aircrafts; biomaterials; tools; machine parts of chemical plants and the like; chemical reactors; structural materials for civil engineering/buildings and the like; consumer goods.

### DESCRIPTION OF SYMBOLS

10 Target Metal
12 Carbon Source Powder
16 Heating Furnace
17 Treatment Chamber
18 Gas Cylinder
S Closed Space (nitrogen gas atmosphere)

What is claimed is:

1. A method of treating a metal surface, characterized in that, heat-treating a target metal in nitrogen gas atmosphere, in such a state where the target metal is buried in a carbon source powder comprising a carbon powder and a powder of iron or an iron alloy mainly comprising iron and containing carbon, whereby the surface of the target metal is at least nitrided or nitrogen-absorbed to modify the surface.

2. The method of treating a metal surface according to claim 1, characterized in that a heating temperature is set between 600° C. and 1200° C.

3. The method of treating a metal surface according to claim 2, characterized in that the heating temperature is set between 700° C. and 1000° C.

4. The method of treating a metal surface according to any of claims 1 to 3, characterized in that the carbon powder is a powder of a material mainly comprising carbon such as graphite or activated carbon or charcoal.

5. The method of treating a metal surface according to any of claims 1 to 4, characterized in that the iron alloy comprises carbon steel or cast iron.

6. The method of treating a metal surface according to any of claims 1 to 5, characterized in that, the carbon source powder is prepared by mixing the carbon powder and a carbon steel powder or a cast iron powder in a ratio ranging from 3:7 to 7:3 by volume.

7. The method of treating a metal surface according to any of claims 1 to 6, characterized in that the target metal is titanium or a titanium alloy.

8. The method of treating a metal surface according to any of claims 1 to 6, characterized in that the target metal is stainless steel.

9. The method of treating a metal surface according to any of claims 1 to 6, characterized in that the target metal is a metal of the 4A, 5A, 6A groups in the periodic table or an alloy thereof.

10. The method of treating a metal surface according to any of claims 1 to 6, characterized in that the target metal is a composite material comprising a metal of the 4A, 5A, 6A groups in the periodic table or an alloy thereof and stainless steel.

11. A surface-modified metal product, which is obtainable by the method of treating a metal surface according to any of claims 1 to 10, and on which a surface modified layer that is at least nitrided or nitrogen-absorbed is formed.
